(19) United States
(12) Patent Application Publication
(10) Pub. No.: US 2012/0028505 A1
(43) Pub. Date: Feb. 2, 2012

(54) Power Strip with Articulatable Outlets

(76) Inventors: Michael Weber, Collegeville, PA (US); Eric Burkett, Hillsborough, NJ (US); Brian Zigmond, Newark, DE (US)

(21) Appl. No.: 13/184,552

(22) Filed: Jul. 17, 2011

Related U.S. Application Data
(60) Provisional application No. 61/368,851, filed on Jul. 29, 2010.

(51) Int. Cl. H01R 33/92

(52) U.S. Cl. 439/638

(57) ABSTRACT

The present invention disclosed relates to a flexible electrical outlet strip that is comprised of a series of electric receptacles joined by independent ball and socket modules. Each ball and socket module is electrically interconnected with the power source and capable of rotating 360 degrees while maintaining electrical continuity. Each ball and socket connection also provides up to 60 degrees of pivotal movement at each socket joint. A fixed single-axis pivotal hinge joins receptacles 1, 2, 3 to 4, 5, 6 increasing mobility and possible outlet configurations. Combined, these characteristics will enable each electric receptacle to be positioned in a unique configuration to accommodate bulky and odd-shaped plugs and power adapters, conform into flexible shapes and designs for space constrained areas, hang or wrap around objects, and assist with cord management.

### CROSS REFERENCE TO RELATED APPLICATIONS

This application claims the benefit of provisional patent application Ser. No. 61/368,851, Filed 2010 Jul. 29 by the present inventors

### BACKGROUND

### Prior Art

The following is a tabulation of some prior art that presently appears Relevant:

### U.S. Pat. Nos.

| Patent Number | Kind Code | Issue Date | Patentee |
|---|---|---|---|
| 7,607,928 | B2 | October 2009 | Schriefer |
| 7,393,250 | B2 | July 2008 | Tanaka |
| 7,264,514 | B2 | September 2007 | Hsu |
| 7,557,297 | B2 | July 2009 | Axland |
| 7,497,740 | B2 | March 2009 | Mei |
| 5,848,915 | A | December 1998 | Canizales |
| 6,315,617 | B1 | November 2001 | Al-Sabah |
| 7,510,426 | B2 | March 2009 | Hwang |
| 6,780,038 | B1 | April 2004 | Huang |
| 7,544,100 | B2 | June 2009 | Teitelbaum |

### LIST OF REFERENCE NUMERALS UTILIZED IN THE DRAWINGS

10—Power Strip with Articulatable Outlets
20—Power Cord
30—Conventional Power Plug
40—Master Switch
50—Surge Protector Reset
100—Power Strip Housing
120 (a, b, c, d, e, f)—Articulatable Links of the Power Strip
130—Outlet Receptacle
140—Hinged Joint
142, 144—Hinged Leaves
160—Ball, for Ball-and-Socket Joint
162—Surface of Ball, for Ball-and-Socket Joint
170—Socket, for Ball-and-Socket Joint
172—Inner Surface of Socket for Ball-and-Socket Joint
174—Opening for Ball-and-Socket Joint
190—Loop-style Anchor
194—Hook
200—Rotor Assembly
210—Floating Plate of Rotor Assembly
212—Circular Floor of Floating Plate of Rotor Assembly
214—Peripheral wall of Floating Plate of Rotor Assembly
216, 218, 220—Concentric Annular Dividing Walls of Floating Plate of Rotor Assembly
222 (a, b, c)—Conductive Rings of Floating Plate of Rotor Assembly
230—Fixed Plate of Rotor Assembly
232—Circular Floor of Fixed Plate of Rotor Assembly
234—Peripheral wall of Fixed Plate of Rotor Assembly
236, 238, 240—Concentric Annular Dividing Walls of Fixed Plate of Rotor Assembly
242 (a, b, c, d, e, f)—Conductive Ball-Bearings of Rotor Assembly
244 (a, b, c)—Conductive Rings of Fixed Plate of Rotor Assembly
250—Interconnected Wires
255—Fastener for Rotor Assembly
257—Compression Spring for Rotor Assembly
260—Secured Point of Interconnected Wires
e—Equator of the Ball's Outer Surface/Socket's Inner Surface for Ball-and-Socket Joint.

### FIELD OF INVENTION

The present invention relates generally to power strips including multiple electrical outlets for receiving plugs of powerable devices.

### BACKGROUND

Electric power strips are well-known in the art. Such power strips are often used to electrically connect more than one electrically-powered device to a single wall-mounted AC power receptacle. Accordingly, power strips typically include one plug for insertion into the wall-mounted receptacle and several similarly-configured outlets, electrically connected to the power strip's plug, for receiving plugs of devices that are intended to be powered by the power strip. Typical arrangements often further include a master switch for breaking the electrical connection between the power-strip's plug and the power strip's outlets, and a surge-protection device, such as a circuit-breaker.

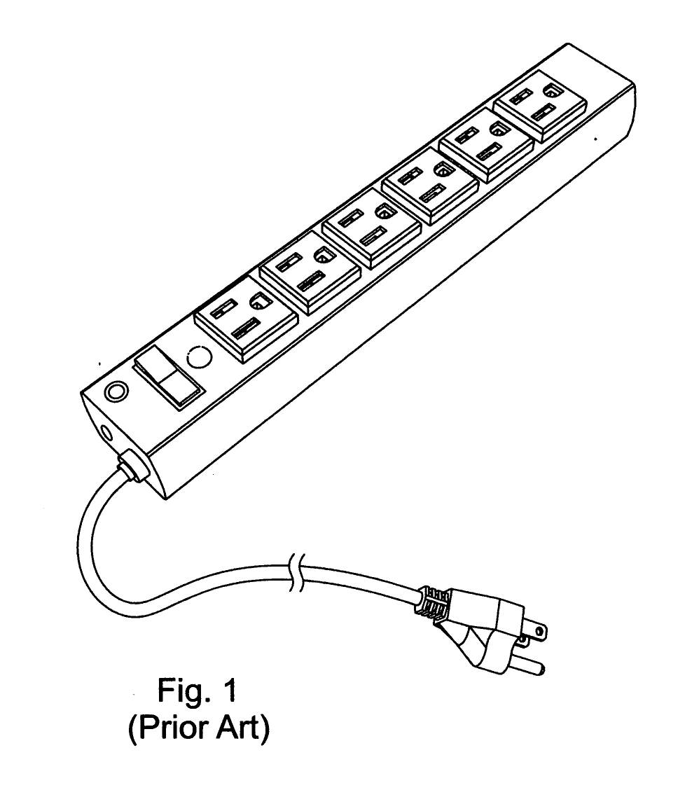

Most power strips include a rigid housing, typically plastic or metal, that supports and/or defines the power strip's outlets. A common arrangement includes a rectangularly-shaped housing supporting six or more outlets in a linear array. Accordingly, it will be appreciated that the spatial relationship among the power strip's outlets is fixed according to the design of the power strip. FIG. 1 shows an exemplary power strip including a rigid housing and a linear array of outlets that is representative of many prior art power strips.

This design was historically useful for standard two-prong and three-prong electrical cord plugs, for 110V devices, such as lamps, alarm clocks, fans, televisions, cable boxes, etc. which could be connected to a typical 110V wall-receptacle in straight-forward fashion. Such standard plugs are typically sized to have a face that is essentially the same size or smaller than the face of the outlet to which it is to be mated. Therefore, typical power strips include closely-spaced outlets, and all outlets were accessible to such standard plugs.

However, many modem electrically-powered devices do not operate on 110V (or other standard wall-receptacle voltage) power platforms. Examples of such devices include most cellular telephones and smartphones power tools, computer peripherals, and the like. As a result, such devices, and/or chargers for batteries for such devices, require transformers to step down the voltage available at the standard wall receptacle. Typically, such transformers are built into the distal end of the power cable of such a device (or its charging device), and as a result, the plug-end of the power cords of such devices is large and bulky, and has face dimensions that exceed the face dimensions of a typical power outlet. Due to the limited space between each closely-spaced outlet on a conventional power strip, it is often the case that an over-sized transformer/plug of one device prevents use of an adjacent outlet.

Therefore, a power strip is needed that facilitates concurrent use of all adjacent outlets of a power strip, even when powering devices having over-sized transformers/plugs. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides a power strip including outlets supported on a rigid housing that includes interconnected but articulatable links. Adjacent rigid links may be manipulated about at least one axis of rotation relative to one another. Accordingly, the outlets may be positioned relative to one another such that a typical over-sized transformer/plug received in one outlet will not preclude use of an adjacent outlet.

In a preferred embodiment, the power strip's housing includes rigid links that are interconnected by at least one of a hinged joint and a ball-and-socket joint. The hinged joint provides a range of motion between adjacent links about a single axis. The ball-and-socket joint provides a range of motion between adjacent links about three orthogonal axes. Each joint is configured to provide for uninterrupted electrical interconnection with the power strip's plug and/or adjacent outlets through the entire range of motion.

Thus, the present invention provides for dramatically-increased outlet configuration flexibility, and allows for all receptacles to be used concurrently, even with oversized transformers/plugs. The articulatable segments also allow a user to form the power strip into various structural shapes, which allows for easy mounting or fastening to hooks or other fixed objects. For example, the power strip may be wrapped around a table leg, or bent into a loop (and in certain embodiments fastened to itself to maintain the loop shape). This distinct feature enables the flexible power strip to be used in a number of circumstances where a rigid power strip would not work well (e.g., to enable the power strip to be wrapped around a leg of a desk/table in a somewhat spirallhelical fashion, where a nontraditional space dictates the necessity of a flexible structure), or where multiple large power adapters are necessary.

### BRIEF SUMMARY OF DRAWINGS

The present invention will now be described by way of example with reference to the following drawings in which:

FIG. 1 is a perspective view of an exemplary prior art power strip including a rigid housing and a linear array of outlets;

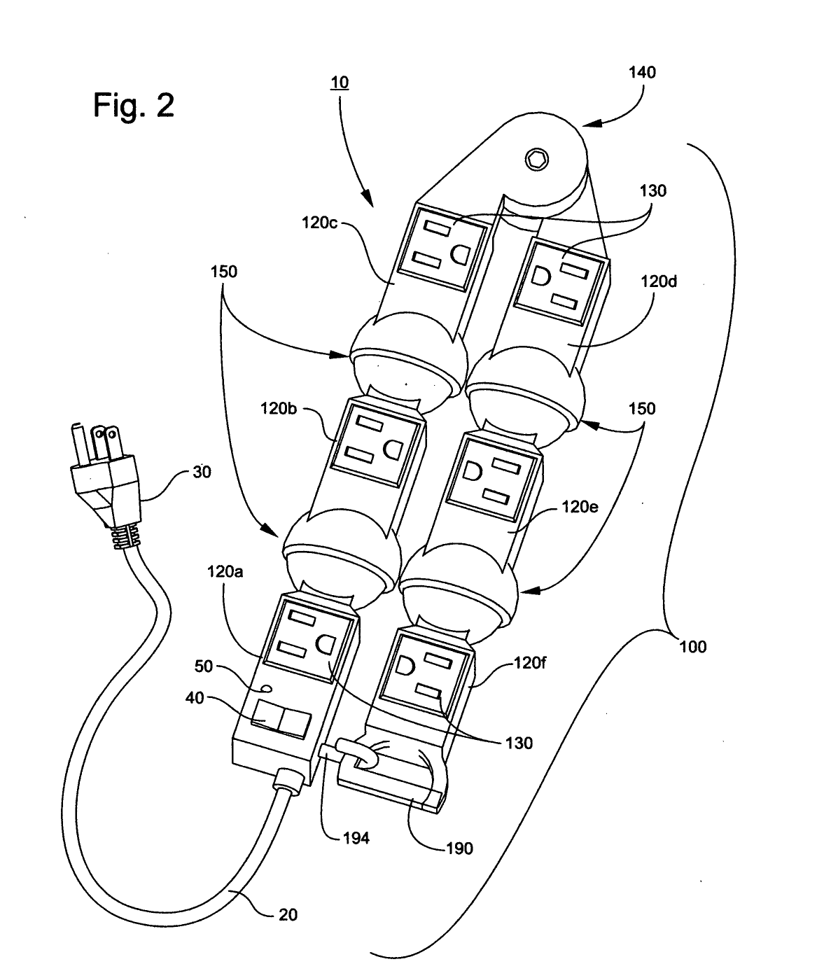

FIG. 2 is a plan view of a power strip with articulatable outlet links in accordance with an exemplary embodiment of the present invention;

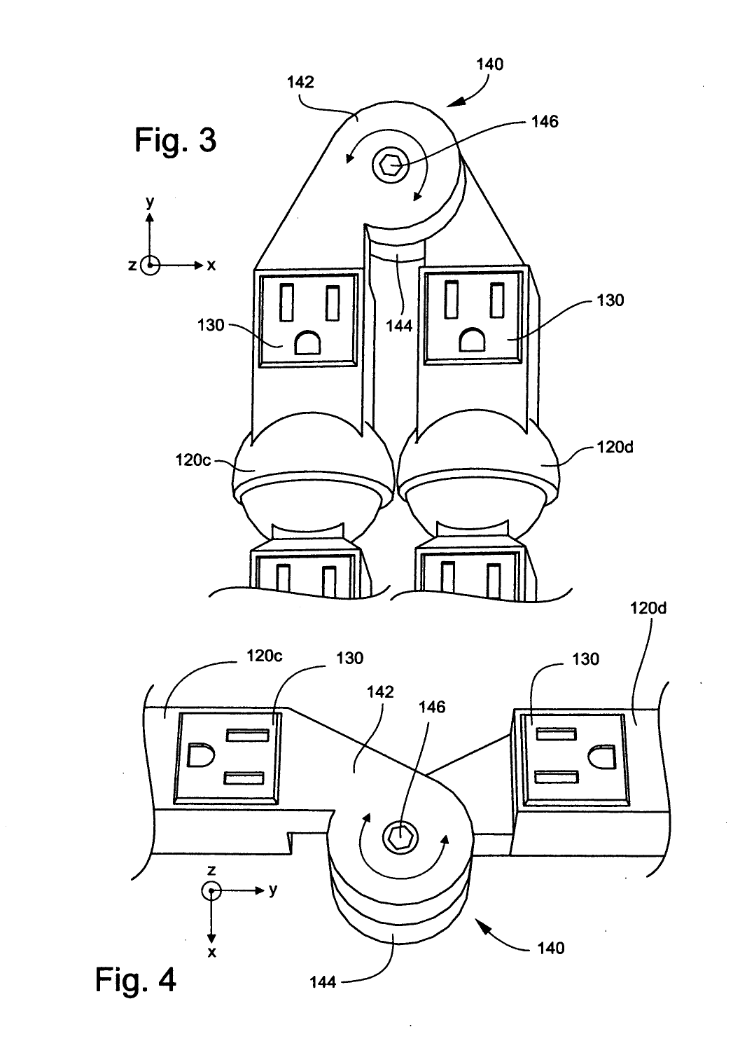

FIGS. 3 and 4 are plan views of the hinged joint of the power strip of FIG. 2;

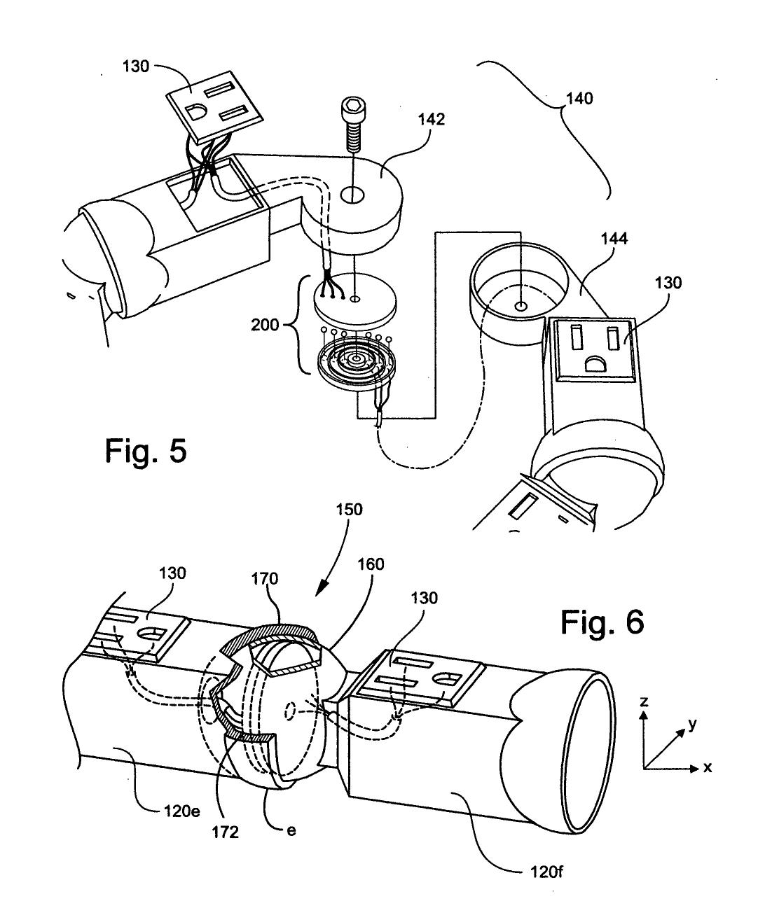

FIG. 5 is a perspective exploded view of the hinged joint of FIGS. 3 and 4;

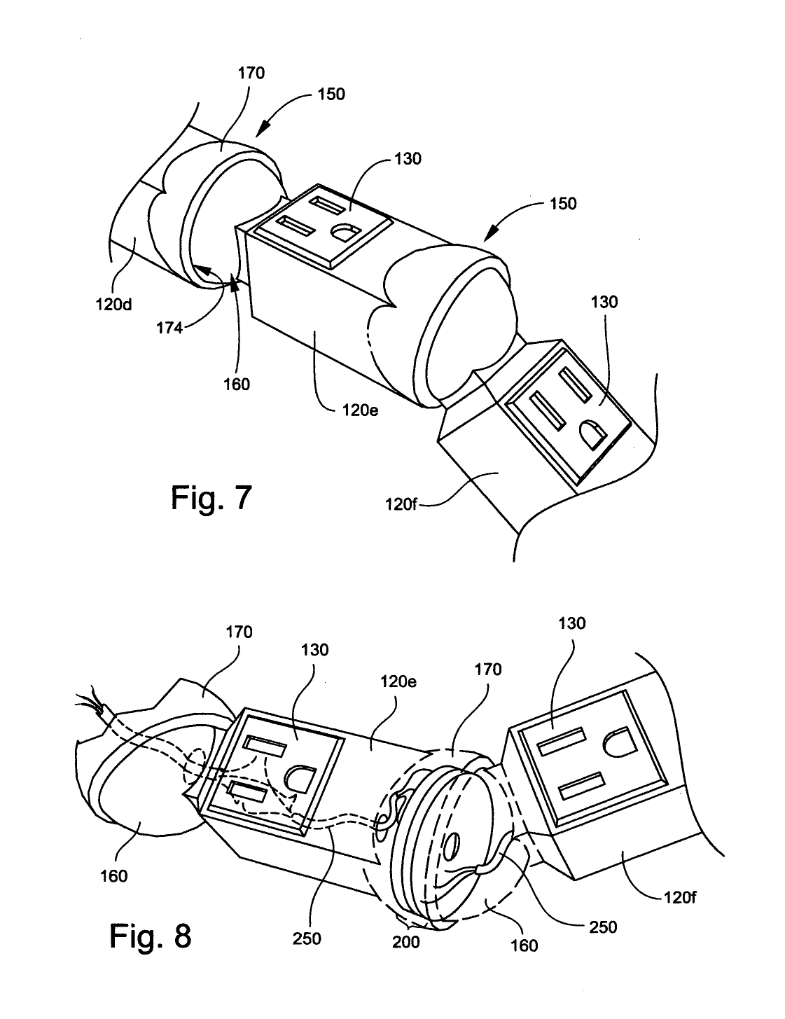

FIGS. 6 and 7 are perspective views showing a ball-and-socket joint of the power strip of FIG. 2;

FIG. 8 is a perspective view showing a rotor assembly for maintaining electrical interconnection through the range of motion of the ball-and-socket joint of FIGS. 3a and 3b;

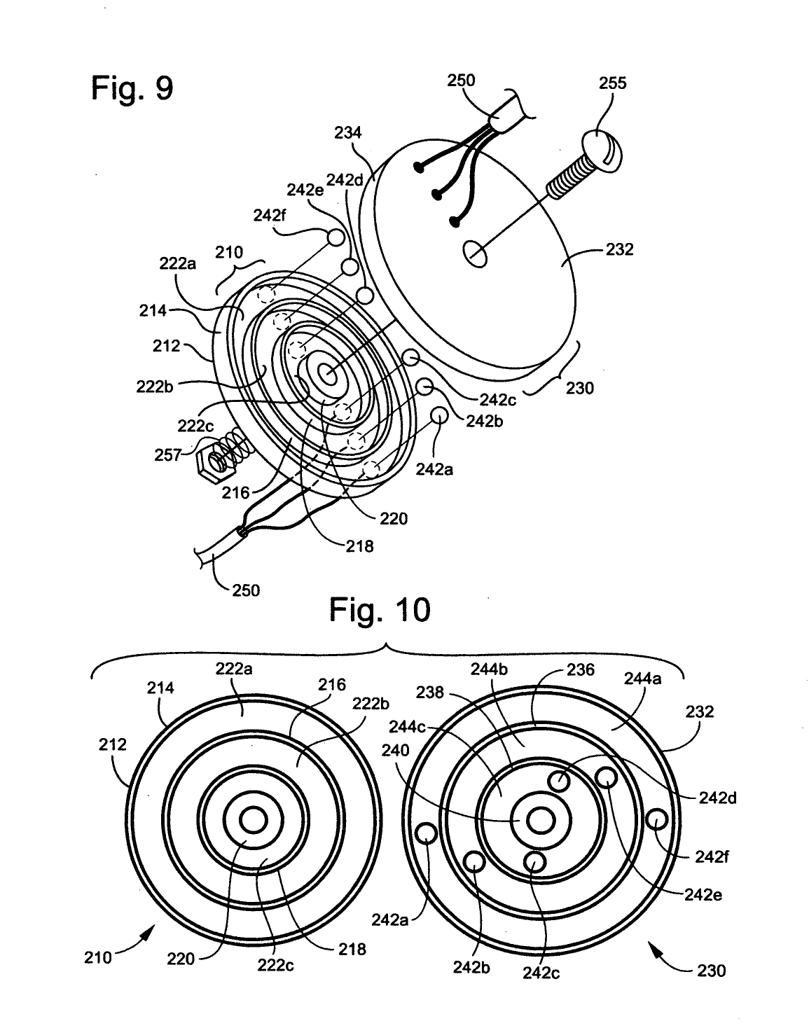

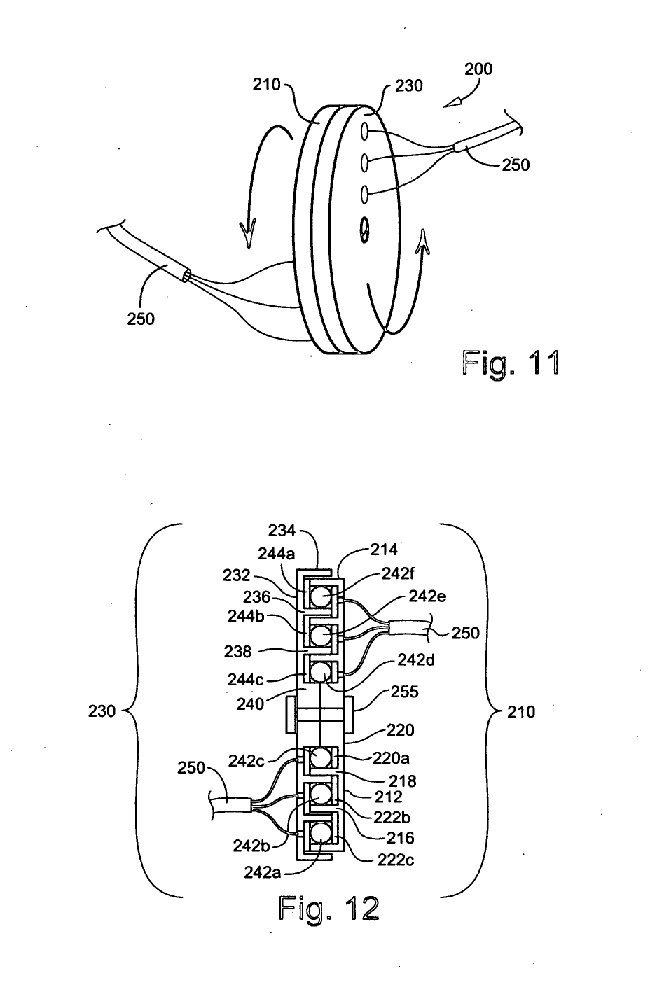

FIGS. 9 and 10 are assembly perspective and plan views, respectively of the fixed plate and floating plate of the rotor assembly of FIG. 8;

FIG. 11 is a perspective view of the rotor assembly of FIG. 8, showing mating of the fixed and floating plates of FIGS. 9 and 10 and their relative rotation;

FIG. 12 is a section view through the assembled rotor assembly of FIG. 8.

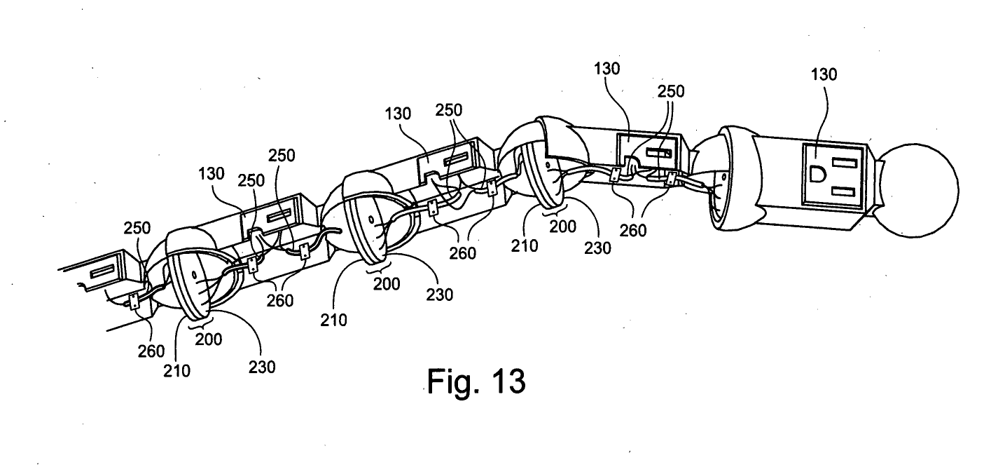

FIG. 13 is a partial sectional view of the power strip of FIG. 2; and

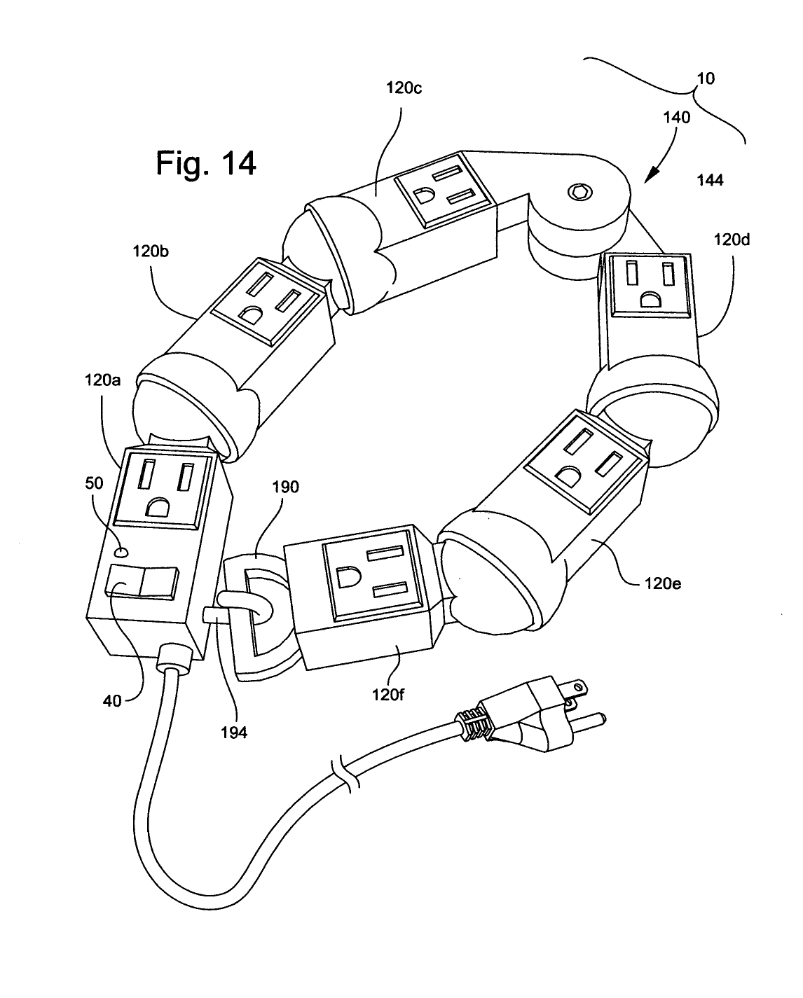

FIG. 14 is a plan view of the power strip of FIG. 2, showing the power strip latched in a closed-loop configuration.

### DETAILED DESCRIPTION

Referring now to FIG. 2, a plan view of an exemplary power strip 10 in accordance with the present invention. The exemplary power strip 10 includes certain conventional features, such as power cord 20 terminating in a conventional power plug 30, a conventional master switch 40, and a conventional surge protector (surge protector not shown, surge protector reset switch 50 shown). By way of example, the power cord 20 may be a conventional power strip power cord housing two 14 AWG insulated conductors and one 14 AWG copper ground wire, and the plug may be a conventional, e.g., NEC-compatible, 110 V plug. By way of further example, the surge protector/fuse may be constructed with current limiting circuitry to prevent power surges, along with a 15 amp fuse to prevent overdraw of current from attached devices. Any conventional technology may be used for these features. Because they are beyond the scope of the present invention, such features are not discussed in detail herein.

In accordance with the present invention, the housing 100 of the power strip 10 includes multiple articulatable links 120. In the exemplary embodiment, each link 120 includes an outlet 130 configured to receive a conventional power plug of an electrically powered device. FIG. 2 shows the preferred embodiment of the orientation of these outlets perpendicular to the long axis of the link, though they may also be positioned parallel to the link as shown in later figures. Each outlet is electrically interconnected with other outlets and/or the power cord/plug so that all outlets may be powered via the power strip's plug.

Each link 120 is constructed of a rigid material such as an insulative plastic material. By way of example, each link may be formed by injection molding fluent plastic material into a suitably configured mold. However, at least two of the links, and preferably all of the links, are interconnected by a joint permitting relative motion between adjacent links. Preferably the joints provide relative rotation about at least one axis.

The exemplary power strip 10 shown in FIGS. 2-14 includes links 120c, 120d connected by a hinged joint 140, and links 120a/120b, 120b/120c, 120d/120e and 120e/120f connected by ball-and-socket joints 150.

Referring now to FIGS. 3-5, an exemplary hinged joint 140 is shown interconnecting links 120c and 120d of the power strip 10 of FIG. 2. Referring now to FIG. 3, links 120c and 120 are specially-formed to include complementary hinge leaves 142, 144 joined for relative motion therebetween. By way of example, the leaves may be joined by a pivot pin, such as a metal pin, a screw, or an integrated plastic pin. Accordingly, links 120c and 120d are pivotable about the pivot pin 146, generally about an axis extending in the z-axis of the Cartesian coordinate system shown for reference purposes in FIG. 3. This exemplary embodiment permits a range of rotational motion from a collapsed position (see FIG. 3), in which the respective outlets 130 of links 120c and 120d are positioned adjacent one another in substantially parallel fashion, to an extended position (see FIG. 4), in which the respective outlets 130 of links 120c and 120d are positioned inverted (opposed by approximately 180 degrees) relative to one another, and preferably lie substantially along a line.

Referring now to FIG. 5, the hinge leaves are constructed to maintain continuous electrical interconnection through the entire range of motion of the hinged joint 140. This may be performed in various ways. For example, in one embodiment, the leaves may simply house wires passing therethrough. In the exemplary embodiment shown, the power strip 10 includes rotor assembly 200 similar to that shown and discussed below with reference to the ball-and-socket joint. More specifically, the hinge leaves 142, 144 act as the fixed and floating plates described below, and contain raceways, conductive rings, and conductive contacts in the form of conductive metallic ball-bearings, as discussed below.

Thus, the position of FIG. 3 provides substantial clearance in the direction of the y-axis (see FIG. 3) and the position of FIG. 4 provides substantial clearance in the direction of the x-axis (see FIG. 3), to accommodate a broad range of differently-shaped, over-sized transformers/plugs. Further, it will be appreciated that the hinged joint 140 allows the power strip 10 to effectively be folded flat against itself (see FIG. 2), for storage and/or use in a compact state. In the embodiment shown in FIG. 2, link 120f is provided with a loop-style anchor 190, and link 120a is provided with a complementary hook 194. In such an embodiment, the power strip 10 can be locked in the folded position of FIG. 3 by engaging the hook 194 of link 120f with the anchor 190 of link 120a.

Referring now to FIGS. 6 and 7, an exemplary ball-and-socket joint 150 is shown interconnecting links 120e and 120f of the power strip 10 of FIG. 2. Each ball-and-socket joint 150 is formed by a ball 160 of one link, e.g., 120f, and a socket 170 of an adjacent link, e.g. 120e. As is typical of ball-and-socket joints, each socket 170 includes an inner surface 172 shaped to accept at least a portion of a sphere, and each ball 160 has an outer surface 162 that has an overall spherical (or partially-spherical) shape for mating with the inner surface 172 of the socket 170. The socket 170 is shaped so that it has an opening 174 that is smaller than the equator e (see FIG. 4a) of the ball's outer surface 162 and the socket's inner surface 172, so that the socket can capture and retain the ball therein for motion relative thereto. Preferably, the opening 174 is only slightly smaller than the ball's equator so that the ball can be press-fit into the socket without permanent damage to the socket or the ball, while permitting a high degree of relative motion between links interconnected by the ball-and-socket joint, as best shown in FIG. 7.

In this exemplary embodiment, the ball-and-socket joint permits 360 degrees of relative rotation about the x-axis (see FIG. 6), about 120 degrees of relative rotation about the y-axis, and about 120 degrees of relative rotation about the z-axis.

Thus, in this exemplary embodiment, which includes six links, each of which is capable of about 60 degrees of angular rotation in each direction about the y and z axes, it is possible to articulate the links to collectively form a closed loop, in a generally circular configuration. In a preferred embodiment, each of the end links 120a, 120f is provided with one of an anchor and a complementary hook. In the embodiment shown in FIG. 2, link 120f is provided with a loop-style anchor 190, and link 120a is provided with a complementary hook 194. This closed loop configuration allows the power strip to be wrapped around certain fixed objects, with the ability to hang freely. For example, the power strip could be wrapped around the trunk of a Christmas tree and locked into place with the hook and anchor. This could provide an elevated location for all Christmas tree light outlets, without laying a power strip on the ground where it may be susceptible to exposure water during watering of the tree.

FIGS. 8-13 show an exemplary rotor assembly 200 that allows for the above described relative motion of the links interconnected by the ball-and-socket joints while maintaining electrical interconnection through the range of motion. Referring now to FIG. 8, the rotor assembly 200 is shown relative to a ball 160 and socket 170. Preferably, the entire rotor assembly 200 is captured within the ball 160. Alternatively, a portion of the rotor assembly is housed within the ball, and a portion is housed with the socket 170.

Referring now to FIGS. 9-12, it will be appreciated that the rotor assembly 200 includes a fixed plate 230 and a floating plate 210. The fixed plate 230 is intended to be fixed to, and rotate with, and associated link. In contrast, the floating plate 210 is intended to rotate, as necessary, relative to the fixed plate during relative rotation of adjacent links about the x-axis. The fixed and floating plates 230, 210, are specially configured to ensure that electrical interconnection is maintained there between through 360 degrees of relative rotation.

Referring now to FIG. 9, it will be appreciated that floating plate 210 is generally disk-like, and includes a substantially flat circular floor 212, a peripheral side wall 214 extending substantially perpendicularly to the floor 212, and a plurality of concentric annular dividing walls 216,218,220 positioned substantially perpendicularly to the floor 212 within the peripheral side wall 214. The floating plate is nonconductive, and the sidewalls collectively define three annular raceways (a first between side wall 214 and dividing wall 216, a second between dividing wall 216 and dividing wall 218, and a third between dividing wall 218 and dividing wall 220). Each annular raceway is lined with a conductive ring 222a, 222b, 222c, such as a ring of copper stamped from a flat sheet, which may be heat-staked or otherwise fit or bonded in the raceway. Each conductive ring is electrically connected to one of the positive, neutral and ground conductors of the power strip circuit. For example, wires 250 may be soldered to contacts electrically connected to these rings, in a manner similar to that shown in FIG. 11 for fixed plate 240.

Further, the rotor assembly 200 includes an attachment fastener 255 through the center of the fixed plate 230 and floating plate 210 in such a manner that it fastens the two together and prevents movement in the axial direction that would cause the conductive ball-bearings to disengage from contact with the conductive rings of the floating and fixed plates, while at the same time permitting relative rotation between fixed plate 230 and floating plate 210. This fastener may be mechanical in nature, such as a conventional bolt and nut as shown, or interference fit split-shaft molded directly into the center of fixed plate 230. The fastener will also incorporate compression spring 257 between the end of the fastener and the floating plate to keep constant pressure on floating plate to ensure that the bearings maintain contact with both opposing faces of the rotor assembly at all times.

Further, the rotor assembly 200 includes an attachment fastener through the center of the fixed plate 230 and floating plate 210 in such a manner that it fastens the two together and prevents movement in the axial direction that would cause the conductive ball-bearings to disengage from contact with the conductive rings of the floating and fixed plates, while at the same time permitting relative rotation between fixed plate 230 and floating plate 210. This fastener may be mechanical in nature, such as a conventional bolt and nut, or integrated plastic pin and capture washer directly into the center of fixed plate 230.

FIG. 13 is a partial sectional view of the power strip of FIG. 2. As best shown in FIG. 7, each rotor assembly 220 is captured within a respective ball-and-socket joint 150. Further, the wires 250, conductive rings 222a, 222b, 222c on floating plate 210, conductive rings 244a, 244b, and 244c on fixed plate 240, and conductive ball-bearings 242a, 242b, 242c, 242d, 242e, and 242f constrained between them collectively provide continuous positive, neutral, and ground electrical paths so that all outlets 130 of the power strip may be powered via the power strip's cord 20 and plug 30.

In use, relative motion of the links 120a, 120b, 120c, 120d, 120e, and 120f is permitted by simply manually grasping the links and manipulating each joint 140, 150. Further, such relative motion is permitted while the integrity of the electrical path is maintained throughout the entire range of motion of each joint. More specifically, as each ball-and-socket joint 150 is rotated about the y- and z-axes (see FIG. 13), no relative motion between the floating and fixed plates 210, 230 is required to maintain the integrity of the electrical paths. However, as each ball-and-socket joint 14 is rotated about the z-axis, the floating plate 210 is permitted to rotate as necessary (i.e., to the extent such rotation cannot be accommodated by simple bending or twisting of interconnecting wires 250) relative to the fixed plate 230 of the same rotor assembly 200. The floating plate 210 may be caused to rotate by the imposition of a torsional force from the attached wires 250. Fixed plate 230 may be braced by internal structures of the ball and or friction therewith, or may be otherwise secured within the ball. Wires may be secured to an internal portion of the housing, e.g. between an outlet 130 and an adjacent fixed plate 230 (since there is no relative rotation therebetween) or between an outlet 130 and adjacent floating plate 210 (such that twisting of the wires 250 relative to the secured point 260, FIG. 13) will cause the transference of torsional force that will cause floating plate 240 to rotate relative to fixed plate 210, and relieve forces on the wires 250 while avoiding torsional or other forces on the end of the wires 250 joining the outlet.

The links 120a, 120f may be latched and unlatched using the anchor and loop 190, 194 in a straightforward fashion, either to lock the power strip in a folded position 9 see FIG. 2) or in a closed-loop configuration (see FIG. 14). The master switch 40 and surge protector 50 can be operated in a conventional manner.

Thus it will be appreciated that the power strip 10 enables pivoting and/or rotation of adjacent links to position the respective outlets 130 to accommodate over-sized large AC adapters/transformers/plugs, and to achieve a flexible footprint to fit into smaller spaces, to hang/wrap around objects for mounting purposes, and to provide enhanced cord management.

While the present invention has been particularly shown and described with reference to the preferred mode as illustrated in the drawing, it will be understood by one skilled in the art that various changes in detail may be effected therein without departing from the spirit and scope of the invention as defined by the claims.

What is claimed is:

1. A power strip comprising:
A power cord comprising a plurality of insulated conductors for carrying electricity, said power cord terminating in a plug adapted for electrical interconnection with a conventional power receptacle; and
a housing supporting a plurality of outlets electrically interconnected with said plurality of conductors of said power cord, said housing comprising a plurality of rigid links, each of said plurality of rigid links supporting at least one of said plurality of outlets, at least two of said links being interconnected by a joint permitting relative rotation therebetween about at least one axis.

2. The power strip of claim 1, wherein said joint comprises a hinged joint comprising at least two leaves relatively rotatable about a single axis.

3. The power strip of claim 1, wherein said joint comprises a ball-and-socket joint
comprising a ball and a socket relatively rotatable about three orthogonal axes.

4. The power strip of claim 1, wherein said ball-and-socket joint may rotate a full 360 degrees axially without sacrificing electrical continuity throughout the device.
